(19) United States
(12) Patent Application Publication
(10) Pub. No.: US 2008/0217951 A1
(43) Pub. Date: Sep. 11, 2008

(54) Vehicle visor with auxiliary sunshade and adjustable slat

(76) Inventor: Thomas E. Aspel, Oceanside, CA (US)

Correspondence Address: LITMAN LAW OFFICES, LTD., P.O. BOX 15035, CRYSTAL CITY STATION, ARLINGTON, VA, 22215, US

(21) Appl. No.: 11/826,140

(22) Filed: Jul. 12, 2007

Related U.S. Application Data
(60) Provisional application No. 60/905,799, filed on Mar. 9, 2007.

(51) Int. Cl. B60J 3/02

(52) U.S. Cl. 296/97.8; 296/97.4

(57) ABSTRACT

The vehicle visor with an auxiliary sunshade includes a sunshade, which is slidably mounted to a vehicle visor so that when the vehicle visor is in a lowered position, the sunshade may be selectively lowered to block environmental light beyond a lower edge of the vehicle visor. The sunshade may be either mounted to an exterior surface of the vehicle visor, or may be mounted within the vehicle visor. The sunshade has a horizontally extending opening formed therethrough, and a slat is rotatably mounted to the sunshade so that the slat selectively covers the horizontally extending opening and is angularly adjustable about a horizontal axis. The angularly adjustable slat allows the user to selectively observe a roadway through the horizontally extending opening with the slat being selectively angled to block interfering environmental light. The slat may alternatively be formed directly within the vehicle visor.

### CROSS-REFERENCE TO RELATED APPLICATION

This application claims the benefit of U.S. Provisional Patent Application Ser. No. 60/905,799, filed Mar. 9, 2007.

### BACKGROUND OF THE INVENTION

1. Field of the Invention

The present invention relates to motor vehicle accessories, and particularly to a vehicle visor with auxiliary sunshade and adjustable slat, and, more particularly, to a vehicle visor, an auxiliary sunshade, and to a rotatable slat mounted in the vehicle visor or in the auxiliary sunshade.

2. Description of the Related Art

Motor vehicles, such as automobiles, trucks and the like, typically include a visor mounted to the roof of the vehicle adjacent the windshield for blocking direct sunlight, which may interfere with the driver's ability to see the roadway. Such visors are typically pivotally mounted to the roof, allowing the visors to be selectively lowered.

Although such typical visors allow for angular adjustment about both horizontal and vertical axes, the dimensions and shape of the visor are typically static. Thus, when the sun is positioned low relative to the horizon, the visor may not be sufficiently sized to block the sun from the driver's view. Such direct exposure to the sun may cause the driver to, essentially, be blinded by the sun's intense illumination, which may result in a motor vehicle accident. Such direct exposure to sunlight may also be damaging to the eyes of the driver.

Although the driver could shield the sun with his or her hand, or may attach an opaque shield to the visor, such an addition would also block the driver's view of the roadway. Thus, a vehicle visor with an auxiliary sunshade and adjustable slat solving the aforementioned problems is desired.

### SUMMARY OF THE INVENTION

The vehicle visor with an auxiliary sunshade includes a rotatable slat mounted within a vehicle visor, allowing the user to view the road and external environment through an aperture formed through the visor. Alternatively, a sunshade that is slidably mounted to the vehicle visor may further be added, such that when the vehicle visor is in a lowered position, the sunshade may be selectively lowered to block environmental light beyond a lower edge of the vehicle visor. The sunshade may be either mounted to an exterior surface of the vehicle visor, or may be mounted within the vehicle visor.

The sunshade may be slidably mounted to the vehicle visor using any conventional means. However, in the preferred embodiment, a pair of rails are mounted to the vehicle visor, with the sunshade being slidably mounted on either end to the pair of rails. The pair of rails may be mounted to an exterior surface of the vehicle visor. Alternatively, the vehicle visor may include front and rear surfaces, with an open interior region being defined therebetween. The pair of rails may be mounted and secured within the open interior region, sandwiched between the front and rear surfaces of the vehicle visor. The sunshade, in this alternative embodiment, is removably and slidably held within the open interior region and projects through a slot formed through a lower edge of the vehicle visor when deployed.

The sunshade has a horizontally extending opening formed therethrough, and an adjustable slat is rotatably mounted to the sunshade so that the slat selectively covers the horizontally extending opening and is angularly adjustable about a horizontal axis. The angularly adjustable slat allows the user to selectively observe a roadway through the horizontally extending opening, with the slat being selectively angled to block interfering environmental light. Alternatively, the adjustable slat may be formed directly in the vehicle visor, rather than being mounted to the separate sunshade.

The slat may be rotatably mounted to the sunshade to selectively cover the opening using any suitable means. For example, the slat may include a louvered connection similar to that commonly associated with Venetian blinds. The slat may be manually adjustable, or may include further means for angular adjustment of the slat. For example, a dial or wheel may be mounted to the sunshade, with the dial or wheel being interconnected, either directly or through a gear train, to the slat, allowing the user to grasp and rotate the dial for selective adjustment of the slat.

Similarly, a handle or tab may be mounted to a lower portion of the sunshade, allowing the user to easily grasp the sunshade and selectively control the vertical deployment of the sunshade with respect to the vehicle visor. Alternatively, selective lowering of the sunshade and angular adjustment of the slat may be automatically controlled via a motor or the like, in connection with any suitable drive means, allowing the user to automatically control the deployment and adjustment of the sunshade and slat.

These and other features of the present invention will become readily apparent upon further review of the following specification and drawings.

### BRIEF DESCRIPTION OF THE DRAWINGS

FIG. 1 is an environmental, perspective view of a vehicle visor with an auxiliary sunshade and an adjustable slat according to the present invention.

FIG. 2 is a rear elevational view of the preferred embodiment of the vehicle visor with an auxiliary sunshade and an adjustable slat according to the present invention.

FIG. 3A is a rear elevational view of an alternative embodiment of the vehicle visor with an auxiliary sunshade and an adjustable slat according to the present invention, with the auxiliary sunshade being shown in a deployed, or lowered, configuration.

FIG. 3B is a rear elevational view of the vehicle visor with an auxiliary sunshade and an adjustable slat of FIG. 3A, with the auxiliary sunshade being shown in a stored, or raised, configuration.

FIG. 4 is a side view of the vehicle visor with an auxiliary sunshade and an adjustable slat according to the present invention, with the auxiliary sunshade being in the lowered configuration of FIG. 3A.

FIG. 5 is a rear elevational view of an alternative embodiment of the vehicle visor with an auxiliary sunshade and an adjustable slat according to the present invention, with the visor broken away to show details of the invention.

FIG. 6A is a side, cross-sectional view of the vehicle visor with an auxiliary sunshade and an adjustable slat of FIG. 2.

FIG. 6B is a side, cross-sectional view of an alternative embodiment of the vehicle visor with an auxiliary sunshade and an adjustable slat according to the present invention.

Similar reference characters denote corresponding features consistently throughout the attached drawings.

### Detailed Description of the Preferred Embodiments

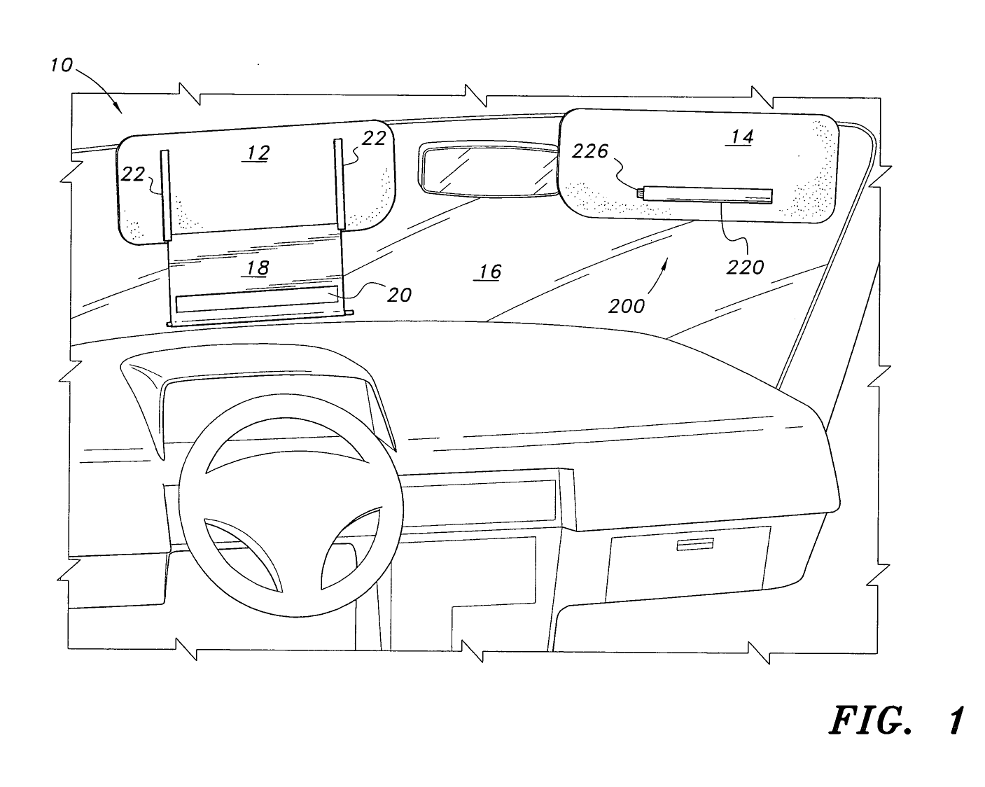

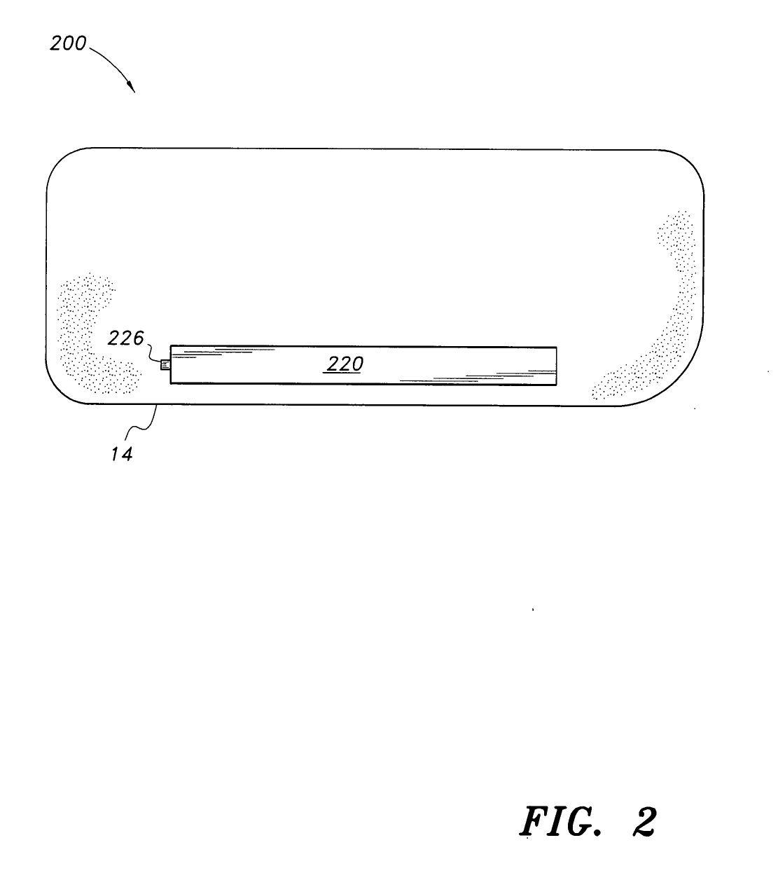

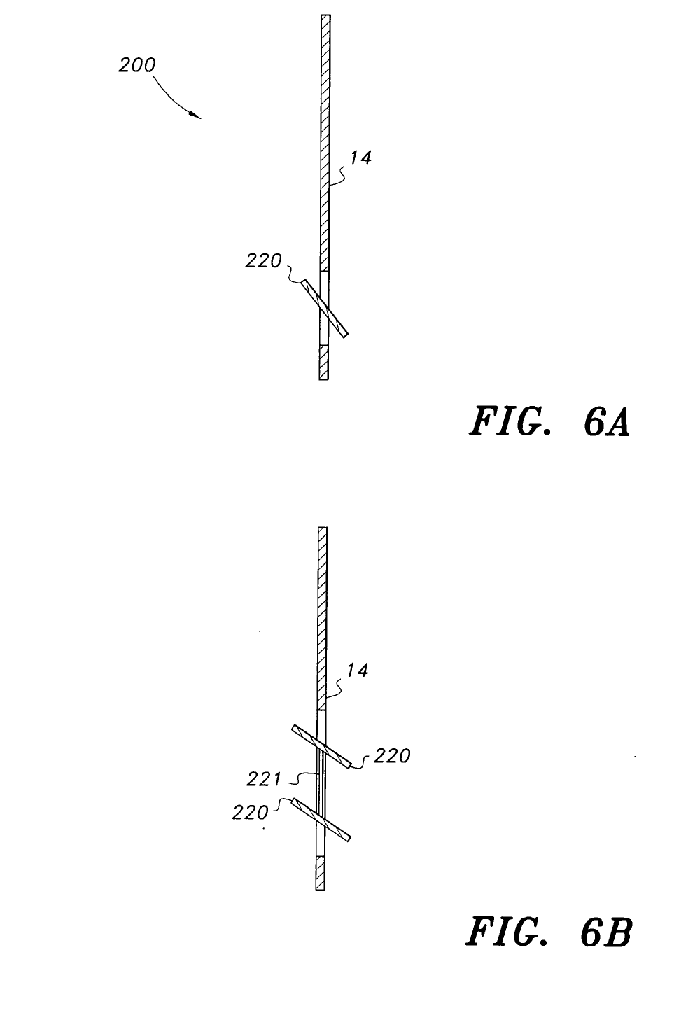

The present invention is directed towards a vehicle visor with an auxiliary sunshade, and further to a rotatable and angularly adjustable slat, mounted to either the auxiliary sunshade or directly to the vehicle visor. FIG. 1 illustrates both system 10, which includes a rotatable slat 20 mounted within a sunshade 18, and system 200, which includes slat 220 mounted directly within vehicle visor 14. In the preferred embodiment 200, illustrated in FIG. 2, rotatable slat 220 is mounted directly within visor 14, and is selectively rotatable via knob 226 or any other suitable turning or rotating element. FIG. 6A illustrates slat 220 selectively angled within the slot formed through visor 14, allowing the user to view the exterior environment through the slot, with the slat 220 adjusted to prevent glare and direct sunlight from striking the user's eyes. In the alternative embodiment of FIG. 6B, a pair of slats 220 are provided, joined to one another by any suitable connector or louver 221. It should be understood that any suitable number of slats 220 may be provided, dependent upon the particular needs and desires of the user.

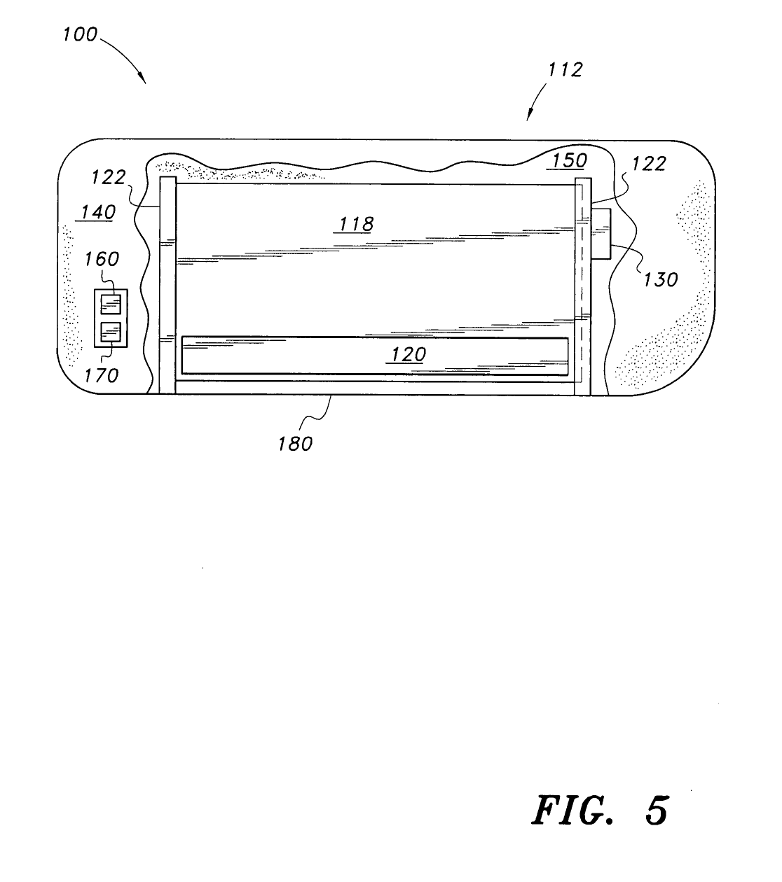

As best shown in FIG. 1, the alternative system 10 includes a sunshade 18, which is slidably mounted to a vehicle visor 12 so that when the vehicle visor is in a lowered position (as shown in FIG. 1), the sunshade 18 may be selectively lowered to block environmental light (such as sunlight when the sun is low with respect to the horizon) shining through windshield 16, beyond a lower edge of the vehicle visor 12. The sunshade may be either mounted to an exterior surface of the vehicle visor (as shown in FIG. 1), or may be mounted within the vehicle visor, as will be described in greater detail below with reference to the embodiment shown in FIG. 5.

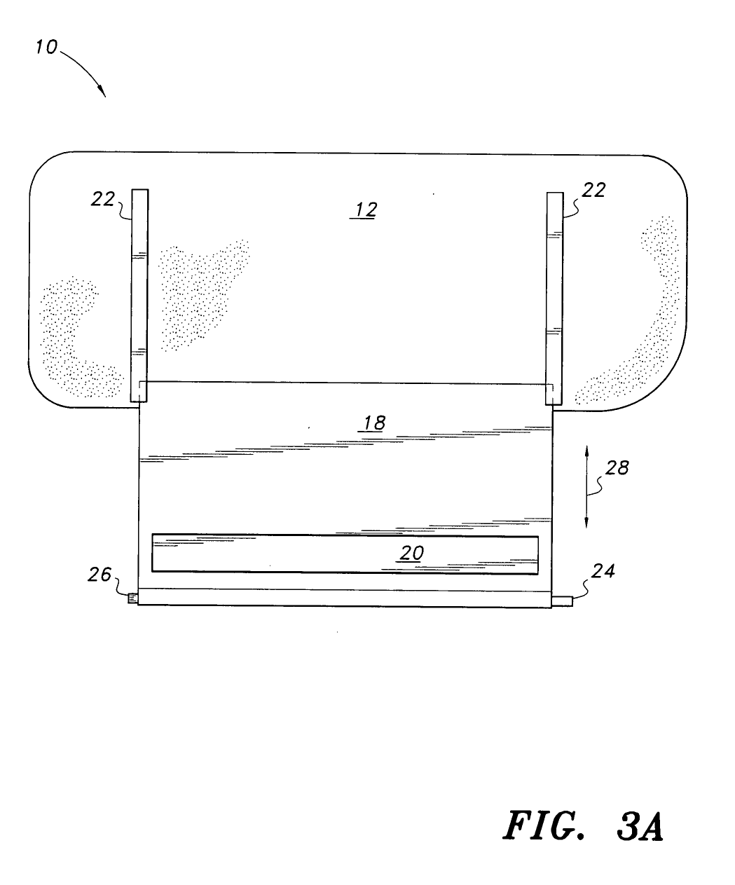

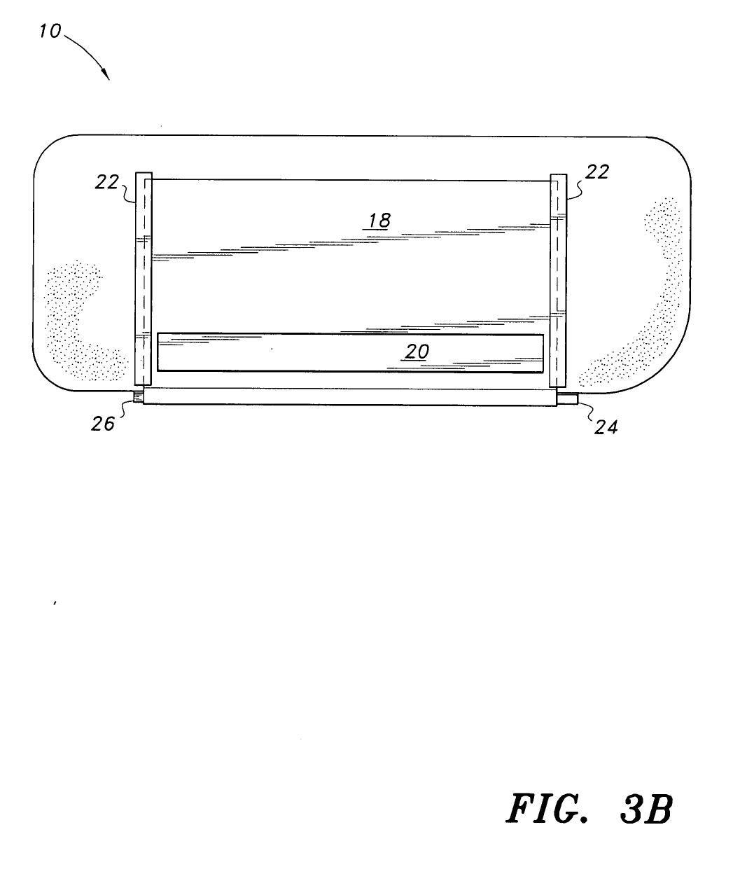

Sunshade 18 may be formed from a partially opaque material, such as tinted or smoked plastic or glass, or from a fully opaque material. Further, although shown as being affixed to the driver's side visor 12 in FIG. 1, the sunshade 18 may also be used with the passenger side visor 14. Although shown as being permanently affixed to visor 12 in FIGS. 3A and 3B, it should be understood that sunshade 18 (and rails 22, to be described in greater detail below) may be removably or releasably fixed to the visor.

The sunshade 18 may be slidably mounted to the vehicle visor 12 using any conventional means. However, preferentially, a pair of rails 22 are mounted to the vehicle visor with the sunshade 18 being slidably mounted on either end to the pair of rails 22, as best shown in FIGS. 3A and 3B. The pair of rails 22 may be mounted to an exterior surface of the vehicle visor 12, as shown in the embodiment of FIGS. 1, 3A, 3B and 4, with the rails 22 either being permanently affixed to the visor 12, or releasably and removably fixed thereto.

Rails 22 are preferably provided for the slidable positioning of sunshade 18, although it should be understood that any suitable means for adjustably positioning and supporting sunshade 18 on the visor 12 may be utilized. For example, a flexible sunshade 18 wound about a central axle or spool may be utilized, with the user selectively unwinding the sunshade 18 in a manner similar to that commonly associated with window shades.

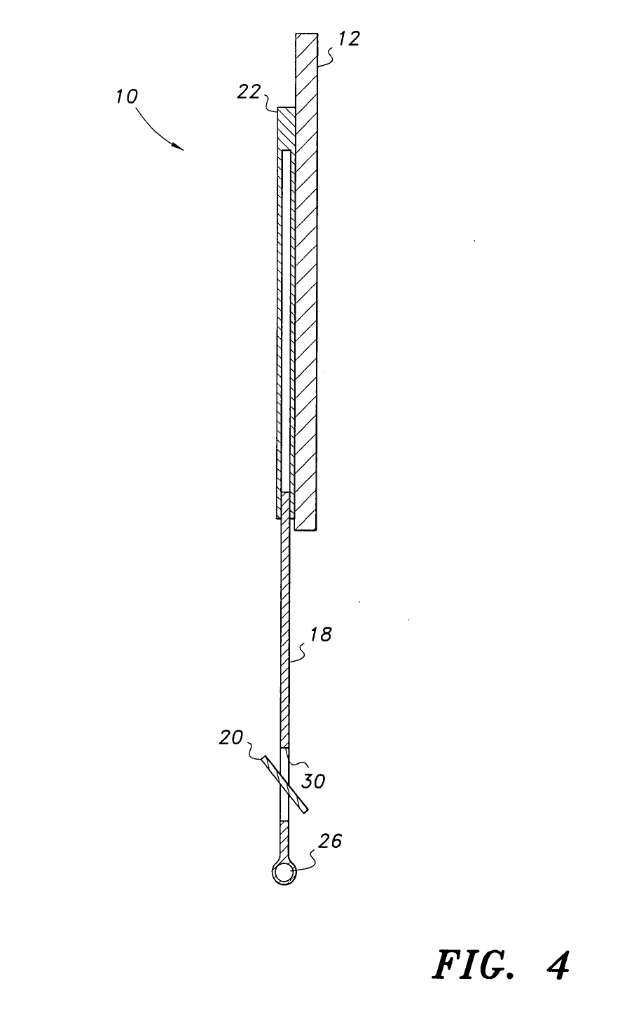

In the embodiment of FIG. 5, the system 100 includes a vehicle visor 112, which includes front and rear surfaces 140, 150, respectively, with an open interior region being defined therebetween. The pair of rails 122 are mounted and secured within the open interior region, sandwiched between the front and rear surfaces 140, 150, respectively of the vehicle visor 112. The sunshade 118, which is similar in construction to sunshade 18 of FIGS. 3A, 3B and 4, is removably and slidably held within the open interior region and projects through a slot 180 formed through a lower edge of the vehicle visor 112 when deployed.

The sunshade 18, 118 has a horizontally extending opening 30 formed therethrough, and a slat 20, 120 is rotatably mounted to the sunshade 18, 118 so that the slat 20, 120 selectively covers the horizontally-extending opening 30 and is angularly adjustable about a horizontal axis (slat 20 is shown as being angled in FIG. 4). The angularly adjustable slat 20, 120 allows the user to selectively observe a roadway through the horizontally extending opening 30 with the slat 20, 120 being selectively angled to block interfering environmental light. In FIGS. 1-5, the slats (and respective openings) are shown as having a substantially rectangular contour. It should be understood that the slats 20, 120 may have any desired dimensions or configuration. Further, slats 20, 120 are preferably formed from materials similar to those forming sunshades 18, 118, although any suitable material may be utilized. Additionally, although shown as only having a single slat 20, 120, it should be understood that visors 10, 100 may include a plurality of slats (such as the stacked or layered slats of Venetian blinds).

The slat 20, 120 may be rotatably mounted to the sunshade 18, 118 to selectively cover the opening 30 using any suitable means. For example, the slat may include a louvered connection similar to that commonly associated with Venetian blinds. The slat 20, 120 may be manually adjustable, or may include further means for the angular adjustment of the slat 20, 1 20. For example, a dial or wheel 26 (in the embodiment of FIGS. 1-3B) may be mounted to the sunshade 18, with the dial or wheel 26 being interconnected, either directly or through a gear train, for example, to the slat 20, allowing the user to grasp and rotate the dial 26 for selective adjustment of the slat 20. As shown, dial or wheel 26 is positioned adjacent the lower edge of sunshade 18 in the exemplary drawings. Thus, when in the stored configuration of FIG. 3B, the dial or wheel 26 does not interfere with the positioning of the sunshade 18 on rails 22. It should be understood that any suitable interconnection, such as gears or a pulley, may be utilized for connecting dial 26 with slat 20. It should be further understood that dial or wheel 26 is shown for exemplary purposes only, and that any suitable means for angular control may be utilized. Further, dial 26 may be positioned anywhere on sunshade 18 or on visor 12.

As noted above, as illustrated in FIG. 2, slat 220 (similar to slat 20) is mounted directly within visor 14, rather than formed as part of a separate sunshade, in the preferred embodiment. Dial or wheel 226 is provided adjacent the slat 220, allowing for selective angular control of slat 220. It should be understood that any combinations of elements from any of the above described embodiments are still within the spirit and scope of the present invention.

Additionally, with regard to embodiment of FIGS. 3A and 3B, a handle or tab 24 may be mounted to a lower portion of the sunshade 18, allowing the user to easily grasp the sunshade 18 and selectively control the vertical deployment of the sunshade 18 with respect to the vehicle visor 12 (illustrated by directional arrow 28 in FIG. 3A). Alternatively, as shown in FIG. 5, the selective lowering of the sunshade 18 and angular adjustment of the slat 20 may be automatically controlled via a motor 130 or the like, in connection with any suitable drive means, allowing the user to automatically control the deployment and adjustment of the sunshade 18, 118 and slat 20, 120. Control buttons 160, 170, which are linked to motor 130, are shown for exemplary purposes only, and any suitable control means that allows the user to selectively control the deployment of the sunshade and angular adjustment of the slat may be utilized. For example, a photocell or any other suitable and desired sensor may be mounted to the visor, allowing the sunshade to automatically deploy when a particular condition (such as the intensity or angle of the sunlight) is satisfied. It should be understood that such a motorized or automatic system may further be applied to preferred embodiment 200 of FIG. 2.

It is to be understood that the present invention is not limited to the embodiments described above, but encompasses any and all embodiments within the scope of the following claims.

1. An auxiliary sunshade for a vehicle visor, comprising:
a sunshade having a horizontally extending opening formed therethrough, said opening being continuously bounded by said sunshade;
means for slidably mounting the sunshade to a vehicle visor, whereby when the vehicle visor is in a lowered position, the sunshade may be selectively lowered to block environmental light beyond a lower edge of the vehicle visor; and
at least one slat rotatably mounted to the sunshade, said at least one slat selectively covering the horizontally-extending opening and being angularly adjustable about a horizontal axis, whereby the user may selectively observe a roadway through the horizontally-extending opening with the slat being selectively angled to block interfering environmental light.

2. The auxiliary sunshade for a vehicle visor as recited in claim 1, further comprising means for selectively rotating the slat.

3. The auxiliary sunshade for a vehicle visor as recited in claim 2, wherein said means for selectively rotating the slat comprises a knob rotatably mounted to a side edge of said sunshade, the knob being rotatably linked to the slat, whereby rotation of the knob drives rotation of the slat.

4. The auxiliary sunshade for a vehicle visor as recited in claim 1, wherein said sunshade has a substantially planar configuration, said sunshade having first and second opposed surfaces, said means for slidably mounting the sunshade to the vehicle visor comprising a pair of rails mounted to the first surface thereof, opposed lateral side edges of said sunshade being slidably mounted to the pair of rails.

5. A vehicle visor with an auxiliary sunshade, comprising:
a planar body having a front surface and a rear surface, the planar body forming a visor, an open interior region being defined between the front and rear surfaces, the visor having a lower edge having a slot formed therethrough;
a sunshade having a horizontally extending opening formed therethrough, said opening being continuously bounded by said sunshade, the sunshade being selectively and removably received within the open interior region of the visor;
means for slidably mounting the sunshade to the visor, whereby when the visor is in a lowered position, the sunshade may be selectively lowered to project through the slot formed through the lower edge of the visor in order to block environmental light beyond the lower edge of the visor; and
at least one slat rotatably mounted to the sunshade, said at least one slat selectively covering the horizontally extending opening and being angularly adjustable about a horizontal axis, whereby the user may selectively observe a roadway through the horizontally extending opening, the slat being selectively angled to block interfering environmental light.

6. The vehicle visor with an auxiliary sunshade as recited in claim 5, further comprising means for selectively rotating the slat.

7. The vehicle visor with an auxiliary sunshade as recited in claim 6, wherein said means for selectively rotating the slat comprises a knob rotatably mounted to a side edge of said sunshade, the knob being rotatably linked to the slat, whereby rotation of the knob drives rotation of the slat.

8. The vehicle visor with an auxiliary sunshade as recited in claim 6, wherein said means for selectively rotating the slat comprises a motor mounted to said vehicle visor, the motor being linked to the slat and selectively driving rotation thereof.

9. The vehicle visor with an auxiliary sunshade as recited in claim 8, further comprising a switch mounted to said vehicle visor, the switch being in electrical communication with the motor for providing selective control thereof.

10. The vehicle visor with an auxiliary sunshade as recited in claim 5, wherein said means for slidably mounting the sunshade to the visor comprises a pair of rails mounted within the open interior region of the visor, whereby opposed lateral side edges of said sunshade are respectively slidably mounted to the pair of rails.

11. The vehicle visor with an auxiliary sunshade as recited in claim 10, further comprising a motor mounted to the visor, the motor selectively driving sliding movement of said sunshade with respect to the pair of rails.

12. The vehicle visor with an auxiliary sunshade as recited in claim 11, further comprising a switch mounted to the visor, the switch being in electrical communication with the motor for selective control thereof.

13. A vehicle visor with an angularly adjustable slat, comprising:
a vehicle visor having a horizontally extending opening formed therethrough said opening being continuously bounded by said visor;
at least one slat rotatably mounted to the vehicle visor, said at least one slat being disposed within the horizontally extending opening and being selectively angularly adjustable therein; and
means for selectively angularly adjusting the slat.

14. The vehicle visor with an angularly adjustable slat as recited in claim 13, wherein said means for selectively angularly adjusting said slat comprises a knob rotatably mounted to a side edge of said slat, whereby rotation of the knob drives rotation of said slat.
